(19) United States
(12) Patent Application Publication
(10) Pub. No.: US 2011/0241310 A1
(43) Pub. Date: Oct. 6, 2011

(54) VEHICLE HAVING VARIABLE WHEELBASE

(75) Inventor: Christopher Donahue, Bethalto, IL (US)

(73) Assignee: Ultimate Innovative Design, Inc, Edwardsville, IL (US)

(21) Appl. No.: 12/976,535

(22) Filed: Dec. 22, 2010

Related U.S. Application Data
(60) Provisional application No. 61/289,873, filed on Dec. 23, 2009.

(51) Int. Cl. B62K 11/02

(52) U.S. Cl. 280/287

(57) ABSTRACT

A system and method for a motorcycle to automatically variably adjust the wheelbase length including a rear swing arm having a length and a rear wheel attached thereto, a prime mover that generates a motive force for selectably extending or retracting the length of the swing arm to extend or retract the rear wheel, and means for lengthening or retracting a motorcycle driveline providing power to the rear wheels.

The present application claims priority to U.S. Provisional Application Ser. No. 61/289,873 filed Dec. 23, 2009, the contents of which are incorporated herein by reference.

### FIELD OF THE INVENTION

This invention relates to vehicles having a variable length wheelbase and in a particular embodiment to a motorcycle having a variable length wheelbase.

### BACKGROUND OF THE INVENTION

Vehicle wheelbase has a large effect on the stability, ride comfort, turning responsiveness and turning radius of a vehicle. Wheelbase is the horizontal distance between the centers (or the ground contact points) of the front and rear wheels of a vehicle. In a motorcycle, wheelbase cannot vary during operation of the motorcycle and is a function of rear frame length, steering axis angle (caster), and fork offset. Different types of motorcycles have different dynamics and these play a role in how a motorcycle performs in given conditions. For example, a longer wheelbase provides more stability in a straight line and a smoother ride at the sacrifice of turning radius and responsiveness. A shorter wheelbase in turn provides greater steering responsiveness and a shorter turning radius at the sacrifice of stability and smoothness.

As discussed above, wheelbase has a major influence on the longitudinal stability of a bike, along with the height of the center of mass of the combined bike and rider. Short wheelbase motorcycles, such as sport bikes, can easily generate enough torque at the rear wheel, and enough stopping force at the front wheel, to lift the opposite wheel off the pavement. These actions, if performed on purpose, are known as wheelies and stoppies, respectively. If carried past the point of recovery, the resulting upset is known as an “endo” (short for “end-over-end”), which can injure or kill the rider. Stoppies and wheelies can be particularly tricky for motorcycle riders to intentionally perform without resulting in an endo because as the wheelie or stoppie is performed, the effective wheelbase of the motorcycle and reduced and, therefore, the amount of braking or accelerating force needs to be reduced or the driver will be thrown from the vehicle.

Because any particular wheelbase for a vehicle is inherently a comprise between responsiveness and stability, a vehicle with an adjustable wheelbase will allow the greatest flexibility for the use of that vehicle. However, because most performance vehicles have an engine attached to a frame and a driveline providing torque from that frame to the rear wheel, the driveline must be able to accommodate a change in driveline length associated with the change in wheelbase. As such, no suitable systems for varying the wheelbase of a vehicle have been developed. Therefore, there is a need in the art for a vehicle having a variable wheelbase.

### SUMMARY OF THE INVENTION

A system and method for a motorcycle to automatically variably adjust the wheelbase length including a rear swing arm having a length and a rear wheel attached thereto, a prime mover that generates a motive force for selectably extending or retracting the length of the swing arm to extend or retract the rear wheel, and means for lengthening or retracting a motorcycle driveline providing power to the rear wheels.

### DESCRIPTION OF THE DRAWINGS

FIG. 1 is a side view of a motorcycle according to an embodiment of the present invention;

FIG. 2 is a left side view of a motorcycle swing arm according to an embodiment of the present invention;

FIG. 3 is a right side view of a motorcycle swing arm according to an embodiment of the present invention;

FIG. 4 is a top view of a motorcycle swing arm according to an embodiment of the present invention;

FIG. 5 is a perspective view of a bridge support according to an embodiment of the present invention;

FIG. 6 is an enlarged side view of an idler and slider gear arrangement according to an embodiment of the present invention;

FIG. 7 is a side view of the slip joint drive shaft according to an embodiment of the present invention; and

FIG. 8 is a left side view of a motorcycle swing arm according to an alternate embodiment of the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

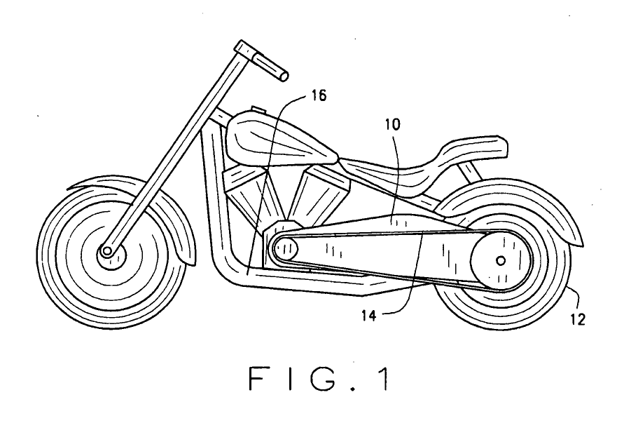

A preferred embodiment of the present invention is a motorcycle having a wheelbase selectively adjustable via a remote control for lengthening and shortening the driveline to accommodate the lengthened or shortened wheelbase. Referring to the Figures generally and to FIG. 1 specifically, there is provided a motorcycle having a swing arm 10, a rear wheel 12 attached to the swing arm 10 and a drive chain 14. The swing arm 10 is pivotally attached to a motorcycle frame 16.

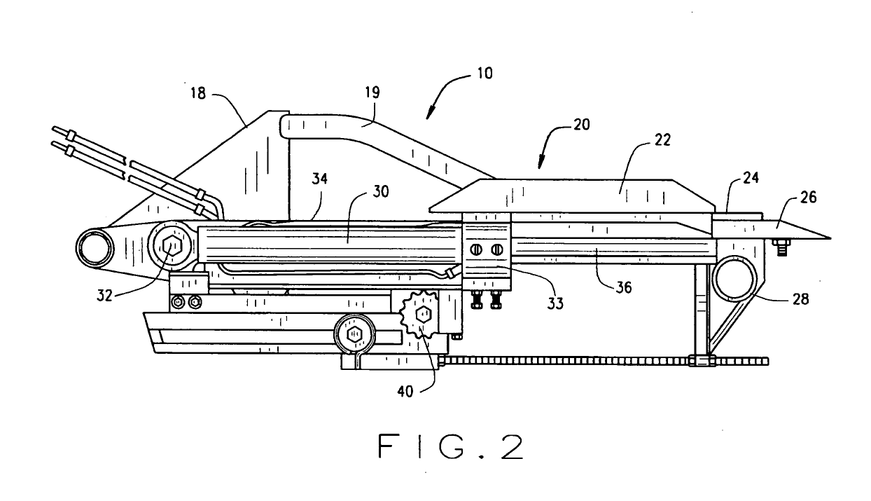

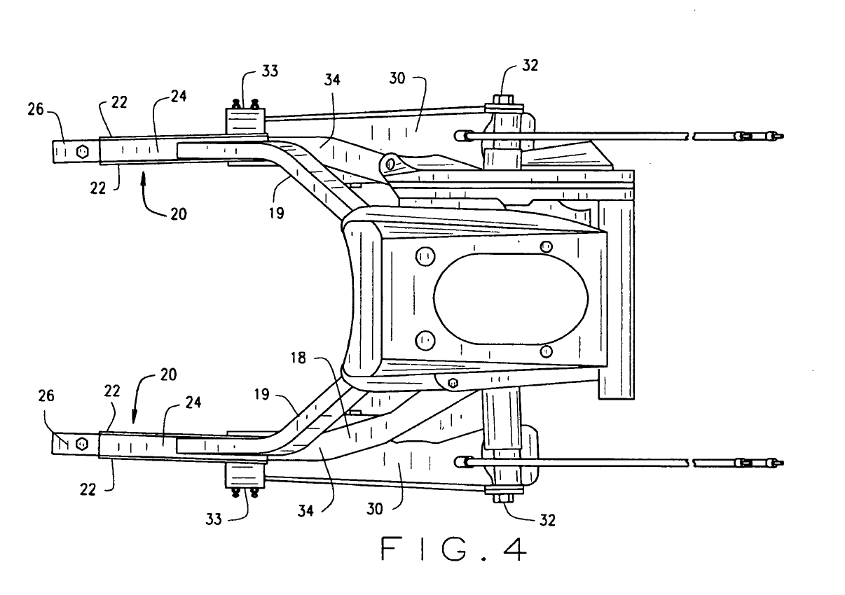

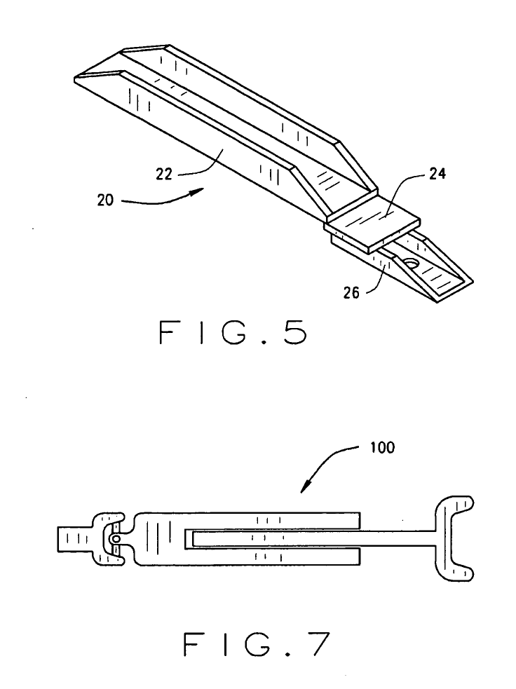

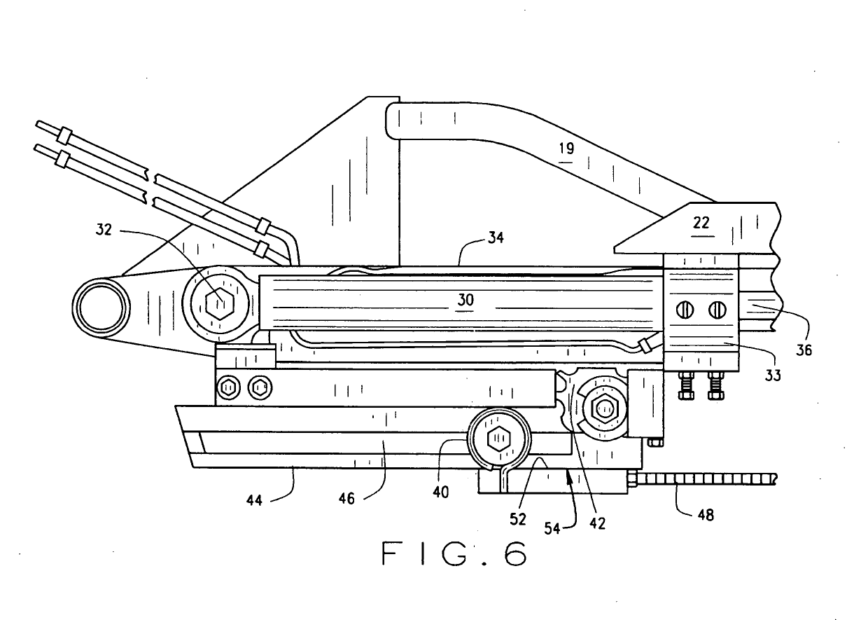

Referring to FIGS. 2-4, the swing arm 10 comprises a swing arm frame 18 which attaches to the motorcycle frame 16 (FIG. 1). The swing arm frame 18 comprises two swing arm bars 19 that extend from the motorcycle frame 16 toward a rear of the motorcycle and each swing arm bar 19 terminates at a respective bridge support 20. Referring to FIG. 5, the bridge support 20 comprises two upwardly extending guard plates 22 attached to a vehicle support plate 24 that defines a horizontal surface. Attached to the vehicle support plate 24 is a wheel flange 26 for attachment to a rear wheel support assembly 28 through which a rear wheel axle is mounted.

As shown in FIGS. 2-4, the termination of the swing arm bars 19 are located between the guard plates 22 of the bridge support 20 and rest upon the vehicle support plate 24. Also, attached to the motorcycle frame 16 are a pair of hydraulic rams 30. The rams 30 are attached to the motorcycle frame 16 at a pivot point 32 and also at a second point 33 to a lower swing arm bar 34. The ram 30 comprises an extension rod 36 that is attached to the wheel flange 26 or rear wheel support assembly 28.

In this manner, by extending or retracting the extension rods 36 from the hydraulic rams 30, the rear wheel support assembly 28 can be moved rearwardly and forwardly by mere operation of the hydraulic ram 30. The bridge support 20 allows sliding movement between the swing arm bar 19 and the vehicle support plate 24, but the vehicle support plate 24 continues to act to support the weight of the vehicle.

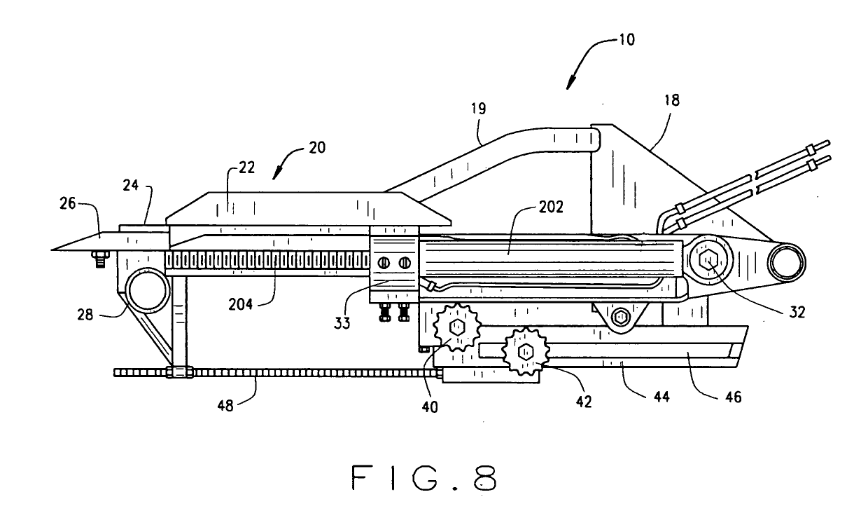

While the use of hydraulic rams is shown and described, after viewing the present disclosure, one of ordinary skill in the art would recognize that various devices for extending the rear wheel support assembly can be implemented in place of hydraulic rams, including for example, the use of stepper motors 202 and helically threaded rod 204 (FIG. 8). The stepper motors would precisely rotate to extend or retract the threaded rod to extend or retract the wheel support assembly 28.

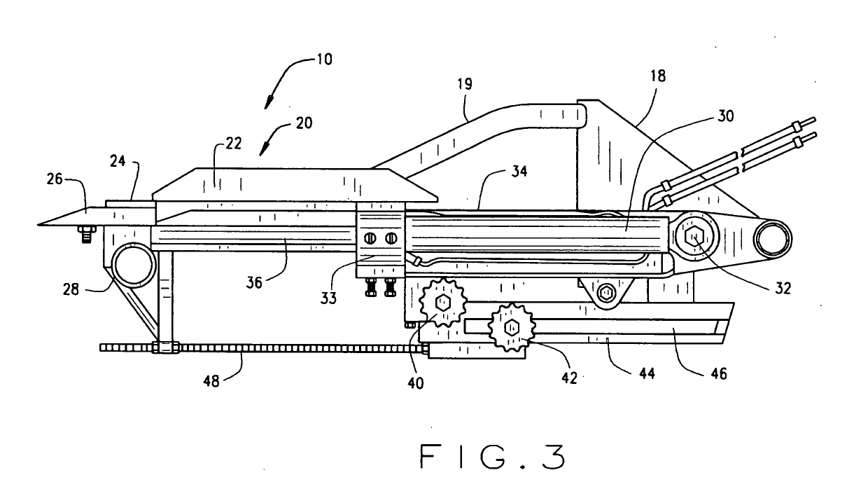

In order to accommodate the resulting increase or decrease in length of the driveline, the preferred embodiment of the invention comprises a driveline adjustment system. In the embodiment described, an idler gear 40 and a slider gear 42 (FIG. 3) are implemented to accommodate the additional length of drive chain 14 necessary for extension of wheel support assembly 28 as the wheelbase is adjusted. The idler gear 40 is attached to the lower swing arm bar 34. The slider gear 42 is located within a slotted lower bracket 44 attached to the lower swing arm bar 34. The slider gear 42 is moveable within the slot 46 of the lower bracket 44. The slider gear 42 is attached to a threaded slider gear linkage rod 48 that is in turn attached the rear wheel support assembly 28 in the preferred embodiment by means of a bracket 50. The slider gear linkage rod 48 and the lower bracket 44 each include flat surfaces 52 and 54 that oppose one another to provide additional support for the slider gear 42. The threaded slider gear linkage rod 48 may be threaded in and out to change the relative distance of the idler gear 40 and the slider gear 42 to accommodate manufacturing tolerances for the length of the chain 14 and to accommodate chain stretch and the chain ages.

When the hydraulic ram 30 is operated to extend or retract the wheelbase of the vehicle as described above, the relative distance between the idler gear 40 and the slider gear 42 is likewise changed because the position of the idler gear 42 remains fixed with respect to the lower swing arm bar 34 and the slider gear 40 extends with respect to the ram 30 with the extension of the extension rod 36. The ram 30 is extended or retracted through the operation of a remote control switch, preferably mounted on the handlebars of the motorcycle. The resulting difference in distance between the idler gear 40 and the slider gear 42 provides additional chain length between the motorcycle transmission (not shown) and the rear wheel 12 when the wheelbase is lengthened. Likewise, a decrease in wheelbase by the hydraulic ram 30 causes the distance between the idler gear 40 and the slider gear 42 to increase, thereby taking up slack chain created by the shortening of the vehicle wheelbase. Moreover, the arrangement of the gears 40 and 42 having fixed positions with respect to one another in any position of the rear wheel 12 (rather than being in a spring loaded arrangement as with derailers on bicycles) allows the idler gear 40 and the slider gear 42 to accept the negative torque that occurs upon deceleration of the vehicle, also known as engine braking.

Finally, one of ordinary skill in the art upon viewing this disclosure would understand that for a shaft driven vehicle, as opposed to a chain driven vehicle, a slip joint drive shaft 100 may be used to provide a drivetrain that will accommodate a change in vehicle wheelbase (FIG. 7).

Further other systems of the vehicle may also require modification to accommodate a changing wheelbase, including rear wheel brake connections (hydraulic or mechanical) that can accommodate changing wheelbase and also exhaust systems including flexible mounts or flexible sections of pipe to accommodate wheelbase length changes.

The above examples show that the invention, as defined by the claims, has far ranging application and should not be limited merely to the embodiments shown and described in detail. Instead the invention should be limited only to the explicit words of the claims, and the claims should not be arbitrarily limited to embodiments shown in the specification. The scope of protection is only limited by the scope of the accompanying claims, and the Examiner should examine the claims on that basis.

I claim:

1. A system for a motorcycle to automatically variably adjust the wheelbase length comprising:
a rear swing arm having a length and a rear wheel attached thereto;
a prime mover that generates a motive force for selectably extending or retracting the length of the swing arm to extend or retract the rear wheel; and
an idler gear that remains in a fixed position with respect to the motorcycle and a slider gear that remains in a fixed position with respect to the rear wheel that cooperate to provide additional, or take in excessive, chain length as the prime mover extends or retracts the motorcycle wheelbase.

2. The device of claim 1 wherein the prime mover comprises at least one hydraulic pump and at least one hydraulic ram.

3. The device of claim 1 wherein the prime mover comprises at least one electric motor that extends or retracts a helically threaded rod.

4. The device of claim 1 wherein the swing arm comprises a swing arm frame which attaches to the motorcycle frame, the swing arm frame comprising two swing arm bars that extend toward a rear of the motorcycle and each swing arm bar terminates at a respective bridge support, the bridge support comprising two upwardly extending guard plates attached to a support plate that defines a horizontal surface, the termination of the swing arm bars located between the guard plates of the bridge support and rest upon the vehicle support plate such that the swing arm bars are maintained in position between the guard plates and are supported by the support plate.

5. The device of claim 1 wherein the idler gear and the slider gear are adapted to adjust a position of the idler gear and slider gear with respect to one another for any selected wheelbase length by adjusting the position of the slider gear with respect to the rear wheel.

6. The device of claim 1 wherein the idler gear is attached to a lower swing arm bar and the slider gear is located within a slot of a slotted lower bracket attached to the lower swing arm bar and the slider gear is moveable within the slot of the lower bracket, and the slider gear is attached to slider gear linkage rod which is attached to a rear wheel support assembly.

7. The device of claim 6 wherein the slider gear linkage rod and the lower bracket each include surfaces that abut and oppose one another to provide support for the slider gear.

8. The device of claim 7 wherein the length of the slider gear linkage rod may be changed to adjust the relative distance of the idler gear and the slider gear with respect to one another for a given wheelbase length.

9. A system for a motorcycle to automatically variably adjust the wheelbase length comprising:
a rear swing arm having a length and a rear wheel attached thereto;
a prime mover that generates a motive force for selectably extending or retracting the length of the swing arm to extend or retract the rear wheel; and
means for lengthening or retracting a motorcycle driveline providing power to the rear wheel.

10. The device of claim 9 wherein the means for lengthening or retracting the motorcycle driveline comprises a two piece drive shaft comprising a slip joint.

11. The device of claim 9 wherein the means for lengthening or retracting the motorcycle driveline comprises an idler gear that remains in a fixed position with respect to the motorcycle and a slider gear that remains in a fixed position with respect to the rear wheel that cooperate to provide additional, or take in excessive, chain length as the prime mover extends or retracts the motorcycle wheelbase.

12. The device of claim 9 wherein the prime mover comprises at least one hydraulic pump and at least one hydraulic ram.

13. The device of claim 9 wherein the prime mover comprises at least one electric motor that extends or retracts a helically threaded rod.

14. The device of claim 9 wherein the swing arm comprises a swing arm frame which attaches to the motorcycle frame, the swing arm frame comprising two swing arm bars that extend toward a rear of the motorcycle and each swing arm bar terminates at a respective bridge support, the bridge support comprising two upwardly extending guard plates attached to a support plate that defines a horizontal surface, the termination of the swing arm bars located between the guard plates of the bridge support and rest upon the vehicle support plate such that the swing arm bars are maintained in position between the guard plates and are supported by the support plate.

15. A method of selectably remotely lengthening a motorcycle wheelbase comprising the steps of:
providing a rear swing arm having a length and a rear wheel attached thereto;
providing a prime mover that generates a motive force for selectably extending or retracting the length of the swing arm to extend or retract the rear wheel;
providing means for lengthening or retracting a motorcycle driveline providing power to the rear wheels; and
with a switch, operating the prime mover to extend or retract the rear swing arm and to operate the means for lengthening or retracting the motorcycle driveline.
an idler gear that remains in a fixed position with respect to the motorcycle and a slider gear that remains in a fixed position with respect to the rear wheel that cooperate to provide additional, or take in excessive, chain length as the prime mover extends or retracts the motorcycle wheelbase.

16. The method of claim 15 wherein the means for lengthening or retracting the motorcycle driveline comprises a two-piece drive shaft comprising a slip joint.

17. The method of claim 15 wherein the means for lengthening or retracting the motorcycle driveline comprises an idler gear that remains in a fixed position with respect to the motorcycle and a slider gear that remains in a fixed position with respect to the rear wheel that cooperate to provide additional, or take in excessive, chain length as the prime mover extends or retracts the motorcycle wheelbase.

18. The method of claim 15 wherein the prime mover comprises at least one hydraulic pump and at least one hydraulic ram.

19. The method of claim 15 wherein the prime mover comprises at least one electric motor that extends or retracts a helically threaded rod.

20. The method of claim 15 wherein the swing arm comprises a swing arm frame which attaches to the motorcycle frame, the swing arm frame comprising two swing arm bars that extend toward a rear of the motorcycle and each swing arm bar terminates at a respective bridge support, the bridge support comprising two upwardly extending guard plates attached to a support plate that defines a horizontal surface, the termination of the swing arm bars located between the guard plates of the bridge support and rest upon the vehicle support plate such that the swing arm bars are maintained in position between the guard plates and are supported by the support plate.
